(19) United States
(12) Patent Application Publication
(10) Pub. No.: US 2015/0022659 A1
(43) Pub. Date: Jan. 22, 2015

(54) LUMINANCE MEASURING APPARATUS

(71) Applicant: IWASAKI ELECTRIC CO., LTD., Tokyo (JP)

(72) Inventors: Tetsuji Yamada, Tokyo (JP); Kosuke Oshima, Tokyo (JP)

(73) Assignee: IWASAKI ELECTRIC CO., LTD., Tokyo (JP)

(21) Appl. No.: 14/382,646

(22) PCT Filed: Feb. 21, 2013
(86) PCT No.: PCT/JP2013/054302

§ 371 Date: Sep. 3, 2014

(30) Foreign Application Priority Data
Mar. 6, 2012 (JP) 2012-049088

(51) Int. Cl. G01J 1/42; G06T 7/00

(52) U.S. Cl. CPC G01J 1/42; G06T 7/0081; G06T 2207/10028; G06T 2207/20112
USPC 348/136

(57) ABSTRACT

The luminance measuring apparatus for measuring the luminance of a road has an image pickup unit for picking up an image of the road, an input unit for inputting information concerning the road as an imaging target, and a luminance measuring unit for defining a luminance measurement target field A on the basis of the information input from the input unit and measuring the luminance within the luminance measurement target field A on the basis of an image picked up by the image pickup unit. The luminance measuring unit divides the luminance measurement target field A of the pickup image into a grid having a predetermined number of lattice intersection points MP in an equivalent of plan view, and allocates measurement points of luminance to the respective lattice intersection points MP.

### CROSS-REFERENCE TO RELATED PATENT APPLICATIONS

This application is a U.S. National Phase Application under 35 U.S.C. §371 of International Patent Application No. PCT/JP2013/054302, filed Feb. 21, 2013, and claims the benefit of Japanese Patent Application No. 2012-049088, filed on Mar. 6, 2012, all of which are incorporated by reference in their entirety herein. The International Application was published in Japanese on Sep. 12, 2013 as International Publication No. WO/2013/133033 under PCT Article 21(2).

### FIELD OF THE INVENTION

The present invention relates to a luminance measuring apparatus for measuring the luminance of a road with image processing.

### BACKGROUND OF THE INVENTION

When road lighting is set up, it is necessary to measure the luminance of a lighting target surface under lighting and check whether the luminance is proper or not. In order to measure the luminance of a road, the luminance of a lighting target surface at many measurement points (for example, 100 points) within the spacing between luminaires of a road is measured by using a spot luminance meter for measuring the luminance of a fixed point, the average luminance within this spacing and the evenness of a luminance distribution within the spacing are measured on the basis of the luminance of each measurement point, and it is checked whether these values are proper or not. As described above, when the spot luminance meter is used, it is necessary to measure the luminance every measurement point, which takes a lot of time. Furthermore, ambient environment (environmental luminance or the like) at the time of luminance measurement is different among the respective measurement points because much time is taken for luminance measurements at many measurement points. Accordingly, it has been difficult to measure the average luminance and the evenness of the luminance distribution with high precision. Therefore, there has been known a luminance measuring apparatus that picks up an image of a luminance measurement target field by image pickup means such as a camera using a solid-state image pickup element (semiconductor image sensor) such as a CCD camera or the like and measures the luminance of a road with image processing for the purpose of shortening the measurement time (see JP-A-2001-148295, for example).

### Problem to be Solved by the Invention

However, when the luminance of a road surface is measured through image processing by using a camera or the like, the area of a luminance measurement target field is an apparent area, and it is different from the actual area of the luminance measurement target field. Therefore, it has been impossible to determine the luminance of the road in the luminance measurement target field with high precision.

The present invention has an object to solve the problem of the above conventional technique, and provide a luminance measuring apparatus that can measure the luminance of a road with high precision through image processing.

### SUMMARY OF THE INVENTION

### Means of solving the Problem

In order to attain the above object, according to the present invention, a luminance measuring apparatus for measuring luminance of a road comprises an image pickup unit that picks up an image of the road, an input unit that inputs information concerning the road as an imaging target, and a luminance measuring unit that defines a luminance measurement target field on the basis of the information input from the input unit and measures luminance within the luminance measurement target field on the basis of the image picked up by the image pickup unit, wherein the luminance measuring unit divides the luminance measurement target field of the pickup image into a grid having a predetermined number of lattice intersection points in an equivalent of plan view and allocates measurement points of luminance to the respective lattice intersection points.

According to the present invention, in the luminance measuring apparatus described above, the luminance measuring unit generates a measurement range mask fitting to the shape and size of the luminance measuring target field corresponding to a road surface as an imaging target on the basis of the information input from the input unit, and the measurement range mask defines the luminance measurement target field A in an image as a processing target picked up by the image pickup unit.

According to the present invention, in the luminance measuring apparatus described above, the luminance measuring unit forms the measurement range mask in any shape and size on the basis of information containing a setup interval of road lighting, a lane width, the number of lanes on the road, a setup height of the image pickup unit and a setup lane of the image pickup unit.

According to the present invention, in the luminance measuring apparatus described above, the luminance measuring unit outputs luminance of each of the lattice intersection points in association with a coordinate of the lattice intersection point.

According to the present invention, in the luminance measuring apparatus described above, the grid is constructed by dividing the image of the luminance measurement target field into a predetermined number of parts at equal intervals in an equivalent of plan view in a travel direction and a traverse direction of the road as the imaging target, and the luminance measuring unit calculates average luminance and evenness of luminance of the luminance measurement target field on the basis of the luminance of each lattice intersection point of the grid.

According to the present invention, the luminance measuring apparatus described above further comprises a display unit that displays an image picked up by the image pickup unit, wherein the measurement range mask is displayed on the display unit while superimposed on the image picked up by the image pickup unit.

### Effect of the Invention

According to the present invention, the luminance measuring apparatus for measuring luminance of a road comprises an image pickup unit that picks up an image of the road, an input unit that inputs information concerning the road as an imaging target, and a luminance measuring unit that defines a luminance measurement target field on the basis of the information input from the input unit and measures luminance within the luminance measurement target field on the basis of the image picked up by the image pickup unit, wherein the luminance measuring unit divides the luminance measurement target field of the pickup image into a grid having a predetermined number of lattice intersection points in an equivalent of plan view and allocates measurement points of luminance to the respective lattice intersection points. Accordingly, the luminance within the luminance measurement target field is measured on the basis of the luminance at the measurement points allocated to the luminance measurement target field in the equivalent of plan view, so that the luminance of the road within the luminance measurement target field can be measured with high precision through image processing of an image picked up by the image pickup unit using a semiconductor image sensor the like.

### BRIEF DESCRIPTION OF THE DRAWINGS

These and other features and advantages of the present invention will become more readily appreciated when considered in connection with the following detailed description and appended drawings, wherein like designations denote like elements in the various views, and wherein:

FIG. 1 is a block diagram showing the construction of a luminance measuring apparatus according to an embodiment of the present invention.

FIG. 2 is a schematic diagram showing a set-up state of a CCD camera under luminance measurement.

FIG. 3 is a diagram showing an example of a measurement condition setting file.

FIG. 4 is a diagram showing a display example of a display unit.

FIG. 5 is a diagram showing a luminance measurement target field and luminance measurement points within the luminance measurement target field.

FIG. 6 is a diagram showing a luminance measurement target field and an example of an output file of a luminance measurement result.

### DETAILED DESCRIPTION OF THE INVENTION

### Modes for Carrying Out the Invention

An embodiment according to the present invention will be described hereunder with reference to the drawings.

A luminance measuring apparatus 1 according to this construction measures the luminance of an lighting target surface of lighting facilities on a road. In order to estimate the performance of the lighting facilities installed on the road, it is necessary to check whether the average luminance of the lighting target surface (road surface or wall surface) of the lighting facilities or whether the luminance distribution of the lighting target surface has the optimum evenness. The luminance measuring apparatus 1 measures the average luminance of the irradiation face of the road lighting facilities and the evenness of the luminance distribution to estimate the performance of the lighting facilities.

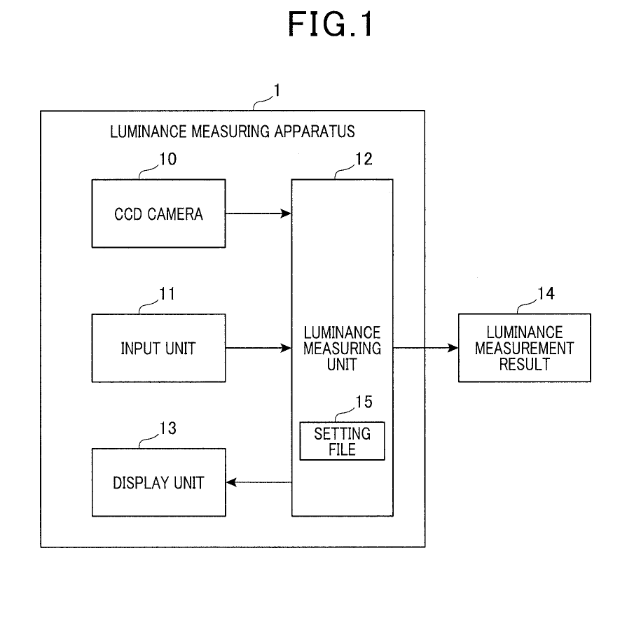

As shown in FIG. 1, the luminance measuring apparatus 1 has a CCD camera 10 as an example of an image pickup unit, an input unit 11, a luminance measuring unit 12 and a display unit 13, and outputs a luminance measurement result 14. The luminance measuring apparatus 1 may be configured to exclude the display unit 13.

The CCD camera 10 inputs a pickup image to the luminance measuring unit 12. The embodiment of the present invention is configured to use a CCD camera using CCD as a solid-state image pickup device (semiconductor image sensor) as an example of the image pickup unit. However, the present invention is not limited to this style, and a camera using CMOS as a solid-state image pickup device may be used as the image pickup unit.

The input unit 11 is configured so as to allow a user to input information concerning the CCD camera 10 and a road as a target to be imaged by the CCD camera 10. The information input through the input unit 11 by the user is output to the luminance measuring unit 12. The luminance measuring unit 12 has a setting file 15 in which the information input by the user is written. When new information is input to the luminance measuring unit 12 through the input unit 11, the luminance measuring unit 12 edits the setting file 15 on the basis of the input information and stores the information.

As described in detail later, the luminance measuring unit 12 generates a measurement range mask 16 for defining a luminance measuring target field A corresponding to a road surface area as a luminance measurement target on the basis of the information concerning the CCD camera 10 and the road as an imaging target of the CCD camera 10, which is input through the input unit 11.

When lighting facilities are set up on a road, the lighting facilities are designed on the basis of standards such as JIS, CIE or the like so that the luminance of the road surface satisfies a predetermined condition. In general, when the lighting facilities are designed, the road surface luminance is calculated every setup interval S of the lighting facilities (every luminaire). A predetermined number of calculation points are set at predetermined positions on the basis of the standards such as JIS, CIE or the like within the spacing (interval) S between luminaires, that is, within a luminance calculation field. The lighting facilities are designed so that the average luminance and the evenness of a luminance distribution of the road surface within the calculation field which are based on the luminance at the respective calculation points within the calculation field satisfy predetermined conditions.

After the lighting facilities are set up on the road, in order to check whether the road surface luminance actually satisfies the predetermined condition based on the standards such as JIS, CIE or the like, the luminance of the broad surface in the luminance measurement target field A is measured every setup interval S of the lighting facilities. In this embodiment, the luminance measurement target field A is similar to the calculation field when the lighting facilities are designed. As described in detail later, the luminance measuring apparatus 1 is configured so that the road surface luminance of the luminance measurement target field A can be accurately determined by extracting, from an image I2 picked up by the CCD camera 10, the luminance of the measurement points (measurement points) similar to the calculation points when the lighting facilities are designed.

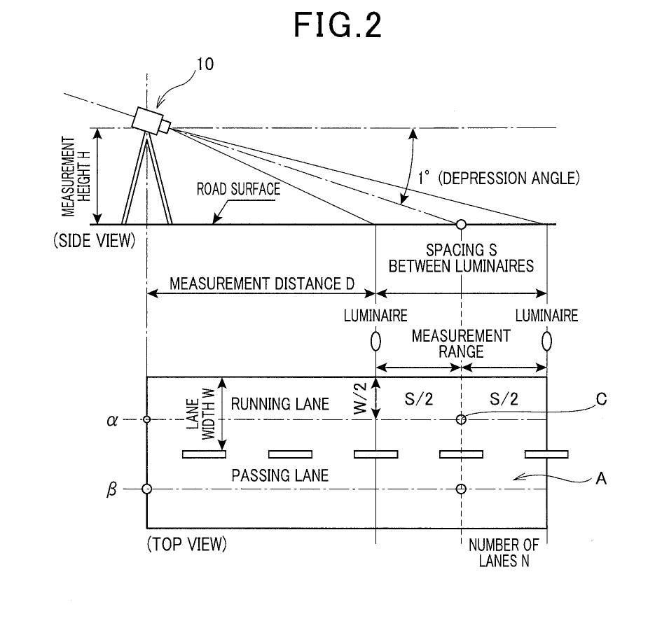

FIG. 2 is a diagram showing an example of the setup state of the CCD camera 10 when the road surface luminance is measured by using the luminance measuring apparatus 1. As shown in FIG. 2, the CCD camera 10 is mounted on a lane axis α of the luminance measurement target field A. The spacing between luminaires of the luminance measurement target field A is represented by S, the measurement distance from the CCD camera 10 to a front luminaire of the luminance measurement target field A is represented by D and the height of the camera is represented by H, the CCD camera 10 are set to have predetermined camera height H and measurement distance D so that the image center C of the CCD camera 10 is located at S/2 on the lane axis α and the depression angle is equal to 1°.

The luminance measurement target field A is set on the basis of the spacing S between luminaires, the lane width W and the number of lanes N. The luminance measuring apparatus 1 is configured so that the luminance measurement target field A to be imaged by the CCD camera 10 can be set in accordance with a road surface as an imaging target, and the luminance measurement target field A is prescribed on the basis of the information which is rewritten in the setting file 15 every imaging target road surface through the input unit 11.

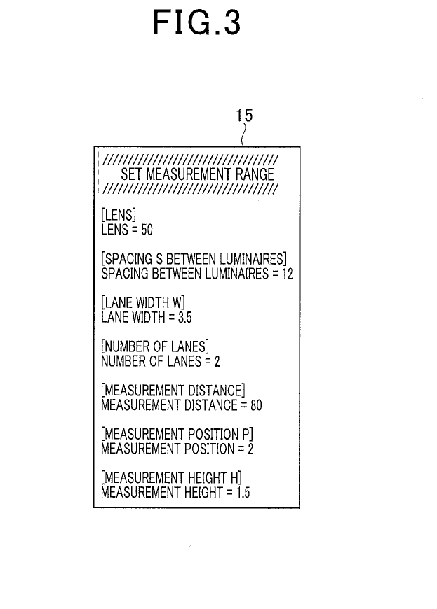

FIG. 3 is a diagram showing an example of the setting file 15, and information such as the spacing S between luminaires, the lane width W, the number of lanes N, the measurement distance D, the camera height (measurement height) H, the measurement position P, the lens focal distance, etc. is written in the setting file 15 in a rewritable style. The measurement distance D and the camera height H may be written in the setting file 15 by beforehand calculating the distance and the height at which the depression angle from the CCD camera 10 to the image center is equal to 1°. Furthermore, the measurement position P serves to set which one of plural lanes within the luminance measurement target field A the CCD camera 10 is set up on. The measurement position P may be set by successively allocating sequential numbers starting from 1 to imaging target lanes from the left-side lane and inputting a corresponding number to the input unit 11.

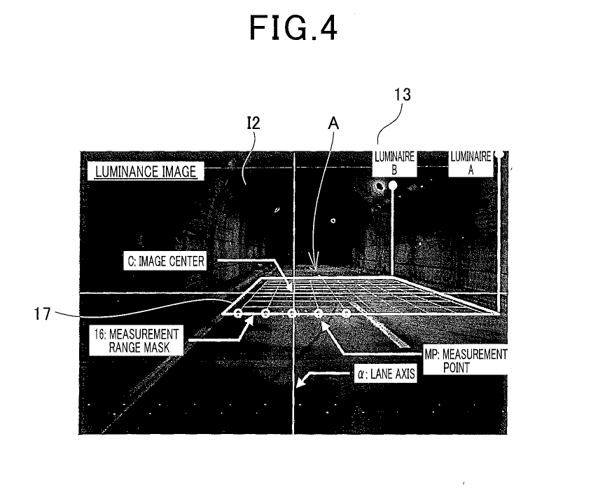

The luminance measuring apparatus 1 generates the measurement range mask 16 corresponding to the luminance measurement target field A on the basis of the information written in the setting file 15. As shown in FIG. 4, the generated measurement range mask 16 is displayed on the display unit 13 of the luminance measuring apparatus 1 while superimposed on the image I picked up by the CCD camera 10. A user adjusts the CCD camera 10 so that the measurement range mask 16 displayed in the image I is matched with a road line shape, and sets the camera height H, the measurement distance D and the image center C so that the measurement range mask 16 is precisely overlapped with the luminance measurement target field A, thereby picking up a processing target image I2 as an image in which the measurement range mask 16 and the luminance measurement target field A are precisely overlapped with each other.

According to this construction, the measurement range mask 16 whose size and shape fit to the road surface as an imaging target is displayed on the display unit 13 when an image is picked up. Therefore, the CCD camera 10 can be adjusted so that the measurement range mask 10 is precisely overlapped with the luminance measurement target field A. Accordingly, the luminance measurement target field A can be accurately set in the image I picked up by the CCD camera 10 in accordance with the condition such as the lane width W, the number of lanes N, etc. of the road surface as a target, thereby enhancing the measurement precision when the luminance of a desired luminance measurement target field A is measured with image processing.

According to this construction, the measurement range mask 16 can be set so as to have size and shape which fit to the image pickup target. Therefore, as omitted from the figures, the luminance measuring apparatus 1 may be configured to be capable of measuring not only the luminance of a road surface, but also the luminance of a wall surface. The setting file 15 is configured to be capable of selecting whether the measurement target is a road surface or a wall surface. The setting file 15 may be also configured to be writable with, for example, information on the height of the luminaire or the like for defining the luminance measurement target field A when the measurement target is a wall surface.

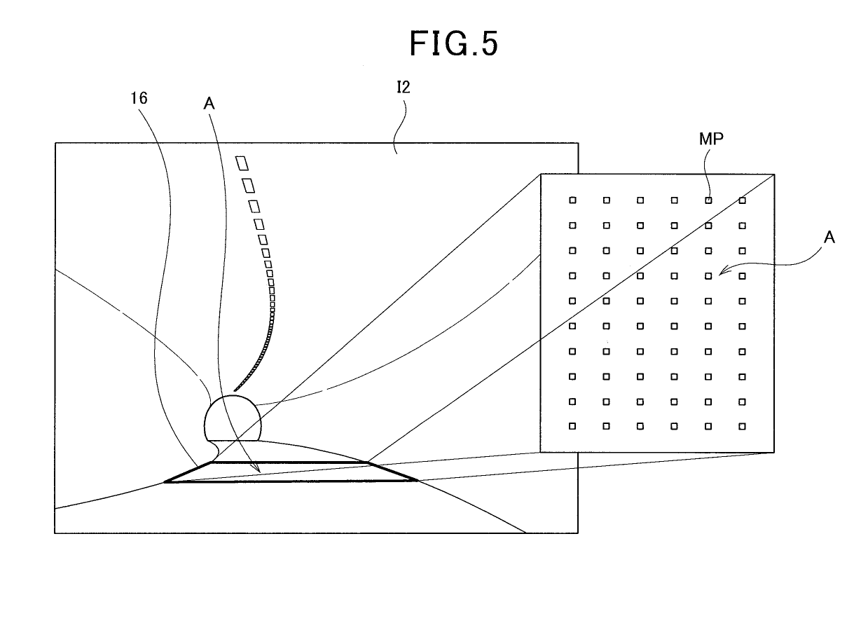

The processing target image I2 picked up by the CCD camera 10 is subjected to image processing in the luminance measuring unit 12 of the luminance measuring apparatus 1 to measure the luminance of the luminance measurement target field A. As shown in FIGS. 4 and 5, the luminance measuring unit 12 divides the luminance measurement target field A in the processing target image I2 into a grid 17 having a predetermined number of lattice intersection points MP in an equivalent of plan view. The grid 17 is constructed by dividing the luminance measurement target field A into a predetermined number of parts in the travel direction and traverse direction of the road as the imaging target, and each lattice intersection point MP of the grid 17 is disposed at the same position as the calculation point of the luminance when the lighting facilities are designed.

Next, the luminance measuring unit 12 extracts the road surface luminance at each lattice intersection point MP from the processing target image I2. That is, the luminance measuring unit 12 allocates measurement points for calculating the average luminance of the luminance measurement target field A to the respective lattice intersection points MP. This is because when the average luminance of the luminance measurement target field A is set to the arithmetic average in luminance of the respective pixels in the luminance measurement target field A, the number of pixels (apparent area) is different between the front side and the depth side of the luminance measurement target field A in the processing target image I2 and thus the above average luminance is not consistent with the average luminance calculated from predetermined calculation points based on the standards such as JIS, CIE or the like. The CCD camera 10 outputs the pickup image I2 with a predetermined number of pixels, and thus the luminance measuring unit 12 calculates (measures) the luminance values of the respective measurement points on the basis of the gray values of cells at the positions of the respective measurement points MP of the measurement range mask 16 disposed in the luminance measurement target field A of the pickup image 12.

According to this construction, the luminance measuring unit 12 arranges the lattice intersection points MP at the same positions as the predetermined calculation points based on the standards such as JIS, CIE or the like in an equivalent of plan view within the luminance measurement target field A in the processing target image I2. Accordingly, the luminance measuring unit 12 can measure, as the road surface luminance of the luminance measurement target field A, the luminance at the same points as the predetermined calculation points based on the standards such as JIS, CIE or the like in the processing target image I2, whereby the average road surface luminance can be accurately determined.

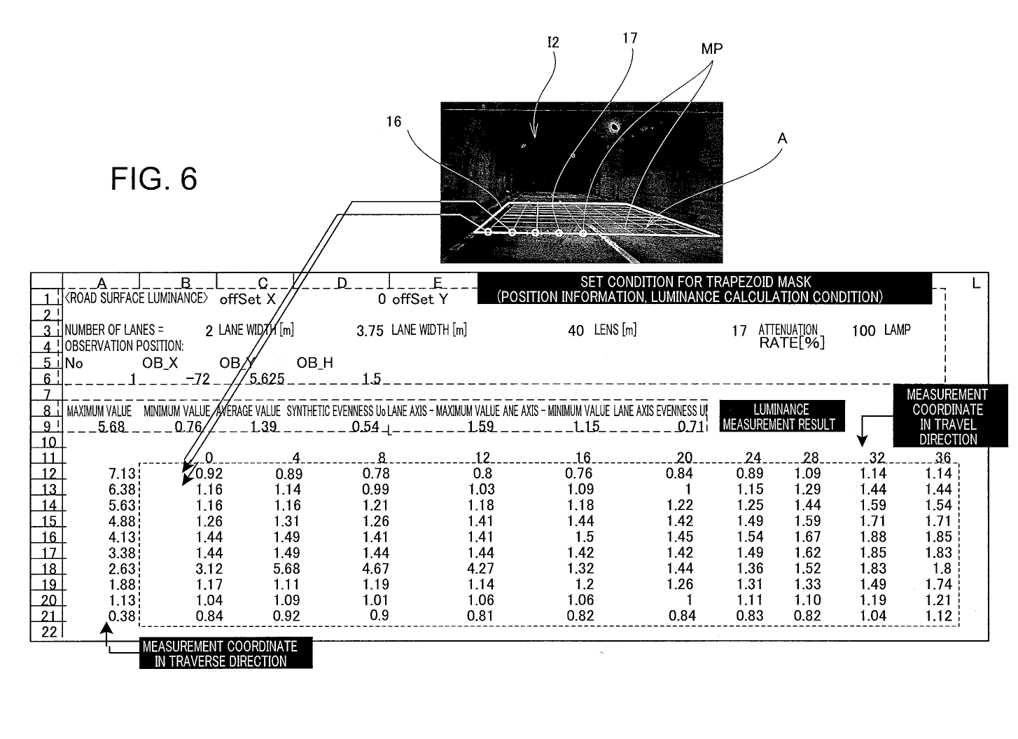

The road surface luminance at the respective lattice intersection points MP extracted from the processing target image I2 by the luminance measuring unit 12 is output in association with the coordinates of the lattice intersection points MP as shown in FIG. 6. Describing in detail, the luminance measuring unit 12 represents the coordinates of the lattice intersection points MP and the luminance at the respective lattice intersection points MP on a spreadsheet. Furthermore, the luminance measuring unit 12 calculates the maximum value of the luminance, the minimum value of the luminance, the average value of the luminance, the synthetic evenness Uo, the maximum value of the luminance on the lane axis α, the minimum value of the luminance on the lane axis α, the evenness on the lane axis α (lane axis evenness) Ul, etc. in the luminance measurement target field A from the spreadsheet, and outputs as a luminance measurement result 14 an output file in which the above results are collected.

According to this construction, one processing target image I2 is picked up, and the road surface luminance of the luminance measurement target field A can be accurately measured, and thus the measurement time can be more greatly shortened as compared with a case where the luminance at each lattice intersection MP is measured by using the spot luminance meter. Furthermore, the road surface luminance at each lattice intersection point MP, the maximum value of the luminance, the minimum value of the luminance, the average value of the luminance, the synthetic evenness Uo, the maximum value of the luminance on the lane axis α, the minimum value of the luminance on the lane axis α, the evenness Ul on the lane axis α, etc. in the luminance measurement target field A are collectively displayed as the luminance measurement result 14 in the output file. Accordingly, the user can easily determine from the luminance measurement result whether the road surface luminance actually satisfies a predetermined condition based on the standards such as JIS, CIE or the like and also whether the lighting facilities correspond to design values.

The luminance measurement result 14 described with reference to this embodiment is a result obtained when the luminance measuring unit 12 determines luminance values for predetermined points determined according to JIS 29111 or CIE 30.2. However, the luminance measurement result 14 of this embodiment is not limited to this result. For example, the luminance measuring unit 12 may determine luminance values for predetermined points corresponding to other standards such as CIE140 or the like, and output the luminance measurement result 14 corresponding to the standards concerned.

As described above, according to the embodiment to which the present invention is applied, the luminance measuring apparatus 1 for measuring the luminance of the lighting target surface under road lighting has the CCD camera 10, the input unit 11 for inputting information concerning a road as an imaging target, and the luminance measuring unit 12 for defining a luminance measurement target field A on the basis of information input from the input unit 11 and measuring the luminance within the luminance measurement target field A on the basis of an image I2 picked up by the CCD camera 10, wherein the luminance measuring unit 12 divides the luminance measurement target field A of the pickup image I2 into a grid 17 having a predetermined number of lattice intersection points MP in an equivalent of plan view and allocates measurement points of luminance to the respective lattice intersection points MP.

According to this construction, the luminance can be calculated, not based on an apparent area in an image, but based on an actual area in an equivalent of plan view, from an image I2 as a processing target of the luminance measuring apparatus 1 for measuring the luminance of the luminance measurement target field A through image processing. Accordingly, the road surface luminance within the luminance measurement target field A can be measured through image processing with high precision by using the CCD camera 10.

Furthermore, according to the embodiment to which the present invention is applied, the luminance measuring unit 12 generates the measurement range mask 16 fitting to the shape and size of the luminance measurement target field A corresponding to a road surface as an imaging target on the basis of information input from the input unit 11, and the measurement range mask 16 defines the luminance measurement target field A in the image I2 which is picked up as a processing target by the CCD camera 10. According to this construction, the luminance measurement target field A whose shape and size fit to the road surface as the imaging target can be defined in the image I2 picked up by the CCD camera 10 on the basis of the measurement range mask 16. Accordingly, the luminance measurement target field A in the image I2 can be changed arbitrarily in shape and size in accordance with a target road surface, and the luminance measurement apparatus 1 can perform luminance measurement based on image processing with high precision.

Furthermore, according to the embodiment to which the present invention is applied, the luminance measuring unit 12 forms a measurement range mask 16 in any shape and size on the basis of information containing the spacing S between luminaires of a road, the lane width W of lanes, the number of lanes N on a road, the setup height H of the CCD camera 10, and a setup lane of the CCD camera 10 (measurement position) P. Accordingly, a measurement range mask 16 which is optimized every luminance measurement target field A can be formed on the basis of the condition of a road surface as an imaging target and the setup condition for the CCD camera 10 available for imaging, and the luminance measuring apparatus 1 can perform luminance measurement based on image processing with high precision.

According to the embodiment to which the present invention is applied, the luminance measuring unit 12 outputs the luminance of each lattice intersection point MP in association with the coordinate of the lattice intersection point MP concerned. Therefore, it can be easily determined whether the luminance within the luminance measurement target field A is excessively high or excessively low and also whether the luminance within the luminance measurement target field A corresponds to the design value of lighting facilities or not.

Furthermore, according to the embodiment to which the present invention is applied, the grid 17 is configured by dividing the image of the luminance measurement target field A into a predetermined parts at equal intervals in an equivalent of plan view in the travel direction and traverse direction of a road as an imaging target, and the luminance measuring unit 12 calculates the average luminance and evenness of luminance in the luminance measurement target field A on the basis of the luminance of each lattice intersection MP of the grid 17. The luminance measurement target field A in the image I2 is a perspective graphic of a road surface, and the apparent area is different between the front and back sides thereof. However, according to this construction, lattice intersection points MP serving as measurement points of luminance can be allocated at the same positions as calculation points for design of lighting facilities in the image of the luminance measurement target field A. Accordingly, the luminance of the road surface can be measured in accordance with, not the apparent area, but the actual area of the luminance measurement target field A in the processing target image I2. Therefore, the average luminance and evenness of luminance of the luminance measurement target field A can be accurately calculated.

Still furthermore, according to the embodiment to which the present invention is applied, the display unit 13 for displaying an image picked up by the CCD camera 10 is provided, and the measurement range mask 16 is displayed on the display unit 13 while superimposed on the image picked up by the CCD camera 10. Accordingly, the user can adjust the CCD camera 10 so that the measurement range mask 16 displayed in the image I displayed on the display unit 13 is fitted to the line shape of a road as a measurement target, fit the camera height H, the measurement D and the image center C so that the measurement range mask 16 is precisely fitted to the luminance measurement target field A, and pick up a processing target image I2 as an image in which the measurement range mask 16 and the luminance measurement target field A are precisely overlapped with each other. Accordingly, the luminance measurement target field A can be accurately set in the image I picked up by the CCD camera in accordance with a road surface condition as a target, thereby enhancing the measurement precision when the luminance of the luminance measurement target field A is measured with image processing.

### DESCRIPTION OF REFERENCE NUMERALS

1 luminance measuring apparatus
I2 processing target image (image)
10 CCD camera (image pickup unit)
11 input unit
12 luminance measuring unit
13 display unit
16 measurement range mask
17 grid
A luminance measurement target field
MP lattice intersection point (measurement point)

1. A luminance measuring apparatus for measuring luminance of a road comprising:
an image pickup unit that picks up an image of the road;
an input unit that inputs information concerning the road as an imaging target; and
a luminance measuring unit that generates a measurement range mask fitting to a road surface as an image target on the basis of information containing at least a setup interval of road lighting input from the input unit, defines a luminance measurement target field in an image as a processing target picked up with the image pickup unit by using the measurement range mask and measures luminance in the luminance measurement target field on the basis of the image, wherein
the luminance measuring unit divides the luminance measurement target field of the pickup image into a grid having a predetermined number of lattice intersection points in an equivalent of plan view and allocates measurement points of luminance to the respective lattice intersection points.

2. (canceled)

3. The luminance measuring apparatus according to claim 1, wherein the luminance measuring unit forms the measurement range mask in any shape and size on the basis of information containing, a lane width, the number of lanes on the road, a setup height of the image pickup unit and a setup lane of the image pickup unit in addition to the setup interval of the road lighting.

4. The luminance measuring apparatus according to claim 1, wherein the luminance measuring unit outputs luminance of each of the lattice intersection points in association with a coordinate of the lattice intersection point.

5. The luminance measuring apparatus according to claim 4, wherein
the grid is constructed by dividing the image of the luminance measurement target field into a predetermined number of parts at equal intervals in an equivalent of plan view in a travel direction and a traverse direction of the road as the imaging target, and
the luminance measuring unit calculates average luminance and evenness of luminance of the luminance measurement target field on the basis of the luminance of each lattice intersection point of the grid.

6. The luminance measuring apparatus according to claim 1, further comprising a display unit that displays an image picked up by the image pickup unit, wherein the measurement range mask is displayed on the display unit while superimposed on the image picked up by the image pickup unit.

7. The luminance measuring apparatus according to claim 3, wherein the luminance measuring unit outputs luminance of each of the lattice intersection points in association with a coordinate of the lattice intersection point.

8. The luminance measuring apparatus according to claim 3, further comprising a display unit that displays an image picked up by the image pickup unit, wherein the measurement range mask is displayed on the display unit while superimposed on the image picked up by the image pickup unit.

9. The luminance measuring apparatus according to claim 4, further comprising a display unit that displays an image picked up by the image pickup unit, wherein the measurement range mask is displayed on the display unit while superimposed on the image picked up by the image pickup unit.

10. The luminance measuring apparatus according to claim 5, further comprising a display unit that displays an image picked up by the image pickup unit, wherein the measurement range mask is displayed on the display unit while superimposed on the image picked up by the image pickup unit.
